(19) United States
(12) Patent Application Publication
(10) Pub. No.: US 2008/0038552 A1
(43) Pub. Date: Feb. 14, 2008

(54) Nanoscale And Supersaturated Solutions Of Mineral Substance And Trace Elements And A Process For The Production Of Nanoparticles, Mixtures Of Nanoparticles, Nanoscale Solutions, And Supersaturated Solutions In General

(76) Inventor: Andreas Noack, Mainz (DE)

Correspondence Address: DEMONT & BREYER, LLC, 100 COMMONS WAY, Ste. 250, HOLMDEL, NJ, 07733, US

(21) Appl. No.: 10/598,466

(22) PCT Filed: Mar. 3, 2005
(86) PCT No.: PCT/EP05/02247

§ 371 Date: Jun. 7, 2007

(30) Foreign Application Priority Data
Mar. 3, 2004 (DE) 10 2004 010 967.2

(51) Int. Cl. B01J 13/00; B32B 5/16; C01B 35/02; C01F 17/00

(52) U.S. Cl. 428/402; 422/236; 423/263; 423/298

(57) ABSTRACT

A process is presented, with the help of which well-balanced mineral substance and trace element preparations with a very high biological value can be prepared. The core of the process is the combination of a special grinding process and a treatment of acids which conform to food. In particular, multi element solutions of nanocluster, as well as general supersaturated solutions of hardly to dissolve species can be prepared by use of the process, which have a high health use. The corresponding mineral substance concentrates are described and specified in detail in this paper as are the multi-component mineral substance preparations and solutions presented for the first time.

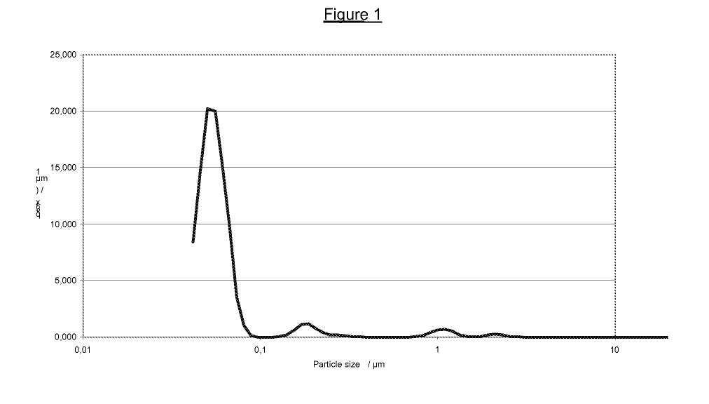

The submitted invention concerns multi-element nanocluster and nanoscale multi-component mineral substance and trace element preparations, as well as a process for the production of nanoscale multi-component mineral substance and trace element preparations, according to the preambles of the independent patent claims.

Trace elements are of high importance for our well being. Many trace elements form the active centres of our enzymes and thereby regulate our complete biochemistry. Nevertheless, since there are many such enzymes which form the basis of our health which are unknown to us, we also do not know those mineral substances and trace elements which we can do without.

The surest way to keep our body mineral substance levels in balance, despite the many demineralized foodstuffs, can be achieved when we, at least from time to time, supply our organisms with a balanced mineral substance preparation.

There are products which contain individual trace elements. With much expenditure in regard to the trace element analysis of our body fluids one can combine a good selection of mineral substance and trace element preparations, which can be taken individually. This however requires considerable expenditure and in the end one must come to the conclusion that our organism possesses only a very inefficient mix function which, in relation to the findings that certain minerals must combine, is to be regarded as a less optimal solution to the problem.

If on the other hand one mixes together available trace element preparations, one sees that they agglomerate with each other or are precipitated and are therefore in the end no longer bio-available.

Although there are methods of producing e.g. Au, Ag or Pt in colloidal form in water, whereby one electrolytically dissolves each of the precious metal electrodes. A balanced trace element distribution is however not possible on the basis of selectively preferred electrolytic solution processes.

According to DE 3727417 A1, many trace elements are supplied to users by a simple incineration of organic materials, and administering the ash. Tests however show that simple ash contains, among other things, very coarse particles of particular minerals, which possess practically no bio-availability.

Additionally a method of improving the body mineralization exists by means of spagyric medication. In this way special medicinal plants are fermented inaqueous suspensions, the distillate is gained and the residue is dried and incinerated. Finally the ash and distillate are recombined, whereby however only the minerals which dissolve well are transformed into the “spagyric tincture”, not however the biologically especially valuable and not easily soluble trace elements. In addition the fermentation products of medicinal plants are to be regarded as medicine, whereby the administrable quantity of minerals and trace elements is highly limited.

The object of the submitted invention is therefore the creation of a process for the production of nanoparticles, mixtures of nanoparticles, nanoscale solutions, as well as supersaturated solutions in general, preferably also such multi-element combinations and well as multi-component mineral substance or multi-component-trace element preparations.

These objects are solved according to the invention with the features of the independent patent claims.

The process according to the invention incorporates the following steps:
a) presentation of a mineral or trace element containing suspension, which contains
i) at least 1 alkaline earth or alkali element in a concentration range of between 1.0 and 50 wt. %, which contains between 2.0 and 25 weight. %, which is at least up to 50% in weight present in a mineral and/or ionically not easily soluble form and
ii) at least 1 element from the
   A Group of the elements, comprising silicon, iron, aluminum, manganese, chrome, boron, titanium, nickel, copper, zinc, vanadium, molybdenum and cobalt, or from the
   B Group of elements, comprising seleniumium, zirconium, rubidium, lithium, yttrium, cerium, palladium, lanthanum, neodymiumium, silver, wolfram, gallium, tellurium, thorium, praseodymium, niobium, samarium, gadolinium, dysprosium, arsenic, scandium, indium, antimony, cesium, germanium and ytterbium, or from the
   C Group of elements comprising erbium, europium, bismuth, platinum, tantalumum, terbium, holmium, rubidium, beryllium, gold and rhodium
in a molar ratio referred to the sum of the alkali and alkaline earth elements between 0.1% and 30%, preferably between 0.3% and 10%, and
b) the introduction of particle dismembering or dispersing energy into the suspension under receipt of a dispersed concentrate and
c) mixing of the dispersed concentrate with acids.

The specialty of the process is the exploitation in particular of the property of the not easily soluble alkaline earth and/or alkali minerals as abrasive agent, in order to disperse and grind those elements which are in general hard to disperse and hard to grind elements
of the A Group, comprising silicon, iron, aluminum, manganese, chrome, boron, titanium, nickel, copper, zinc, vanadium, molybdenum and cobalt, as well as
of the B Group of elements, comprising selenium, zircon, rubidium, lithium, yttrium, ceriumium, palladium, lanthan, neodymium, silver, wolfram, gallium, tellurium, thorium, praseodymium, niobiumium, samarium, gadolinium, dysprosium, arsenic, scandium, indium, antimony, cesium, germanium and ytterbium as well as
of the C Group of elements comprising erbium, europium, bismuth, platinum, tantalumum, terbium, holmium, rubidium, beryllium, gold and rhodium
   with as least as possible or with an expenditure which is possible to be realized to disperse or to crush. Here the consistency of the suspension at concentrations of the at least one alkaline earth or alkali species between 1.0 and 50% in weight, preferably between 2.0 and 25% in weight with a not readily soluble part of at least 50% is advantageous, in order to present sufficient abrasive surfaces.

Categorized for this is that at least one element of the A Group, of the B Group or of the C Group appears in a concentration range between 0.1 and 30 weight. %, preferably between 0.3% and 10 weight % each referred to the sum of the alkali and alkaline earth elements, in order to achieve a good efficiency of the dispersion or dismembering process.

In the final stage the species of the A, B and C Group elements which are embedded in the not easily soluble alkaline earth−/alkali matrix are released in a high quality bio-available form by at least partially dissolving the not easily soluble alkaline earth or alkali mineral matrix.

Therefore, without high temperatures being necessary, in the last acid treatment step nanoscale structures with extremely high bio-availability are released, which in the matrix, as it were, are “temporarily stored”.

As a rule alkali, in particular alkaline earth minerals are used as hard to dissolve inorganic components; calcium and magnesium salts are here the main ones to mention, which especially as oxide, hydroxide, carbonate and hydrogen carbonate possess on the one hand a high abrasiveness, and on the other hand can be easily converted into valuable foodstuffs with for example fruit acids into physiologically valuable substances, the presence of which is advantageous in corresponding mineral substance products.

The mineral substance matrix for the suspension can by this process be prepared from the individual minerals as individual components or can be freely combined.

A further aim of the process is the forming of amorphous nanoscale structures, whereby not easily soluble trace elements are “interwoven” in the form of particles. The formed nanoclusters are, the more “impure” or “multi element” they are constituted, especially bio-available because of their high affinity for reorganization. Because of this, it is especially advantageous to present at least 4 elements from each individually defined element groups in a specified concentration range. In this way each of at least 4 elements, which are present from their natural availability in similar orders of magnitude, are optimally bound with each other and among one another in amorphous structures.

It is advantageous therefore, if the suspension contains at least 4 elements of the A Group in a molar ratio, each referred to the sum of the alkali and alkaline earth elements, between 0.05% and 30%, preferably between 0.1% and 5%.

In addition it is advantageous, if the suspension contains at least 4 elements of the B Group in a molar ratio, each referred to the sum of the elements of the A Group, between 0.05% and 30%, preferably between 0.1% and 5%.

And it is especially advantageous moreover if the suspension contains at least 4 elements of the C Group in a molar ratio, each referred to the sum of the elements of the B Group, between 0.05% and 30%, preferably between 0.1% and 5%.

This grading of the elements into groups among one another, secures therefore, apart from the technical advantages, a physiological nourishment balance.

Preferably the mineral substance matrix is constituted essentially from ash made out of plant and/or animal origin.

The ash is preferably produced thermally by the burning of organic raw materials, may be however also produced alternatively by agents of a plasma process or by altering organic raw materials by activated oxygen species.

Typically, wood, nut shells, fruit stones, fruit peels, especially peels of orange, lemon, potato, onion, olive stones, pine cones, roots, wheat brans, rice husks, aloe vera as well as the rape of various fruit and vegetable types such as carrots, malics, apricots, grapes etc. are used as raw materials.

The use of walnut shells, macadamia nut shells, pistachio shells, brazil nut shells, peanut shells, acorns, coconut shells, hazelnut shells, apricot stones, nectarine stones and other nuts and stones is also advantageous.

Especially advantageous is the use of compressed cakes or of compressed residue, which result from the crushing of oils, like e.g. nuts, especially hazelnut, walnut, macadamia nut, coconut, almond, sun flower seeds, thistles, rapeseed, sesame, olives, peanut, brazil nut, pumpkin seeds pumpkin seeds, grape seeds and similar oil seeds as well as the residue from cane sugar and sugar beet, which occur in the sugar extraction process.

Optionally ash components, which have evaporated during the thermal treatment of the raw materials and are analytically determined, are added in corresponding quantity to the mineral matrix, for example iodine, bromine, fluoride salts and selenium combinations.

The raw material can also be completely or partially extracted in a preceding process and the aqueous extract can be added to the product—optionally also further processed as an easily dispersable dry substance. This has the advantage, that volatile but water-soluble elements or minerals like selenium, iodine, bromineide are not lost in the whole process.

Generally all known grinding technologies can be used, preferred are however in the aqueous range usable mills, as bead mills, centrifugal mills and colloidal mills. With the use of a bead mill, one preferably uses grinding bodies with a diameter of between 0.05 and 2 mm, particularly preferably those which have a diameter of between 0.2 and 0.8 mm.

Also the dispersion and pulverizing can be completed using a high pressure jet method.

By the addition of oxidizing species like hydrogen peroxide, ozone, singlet oxygen or atomic oxygen to the material to be ground or to the suspension, further any remaining traces of organic incineration residue may be eliminated and/or also improve the grinding and dispersing properties. Other dispersing agents such as gelatin, pectin and chelate can also be employed in an advantageous way, in order to stabilize the dispersion.

The pH value of the suspension during the grinding process is additionally an essential parameter controlling the quality of the grinding process, especially the tendency of those particles reduced in size to re-agglomerate. As a rule a pH-value of >3, preferably >7 and especially preferably >10 is set or sets itself according to the choice of mineral matrix. In addition it can in individual cases be advantageous to grind fractions of the material to be ground at different pH-values as well as separately with different stabilizers.

Typically for commination or for the dispersion energies of between 100 and 100.000 kwh/tonne, preferably between 500 and 5000 kwh/tonnes of solids are introduced into the suspension.

In the terminating process of neutralizing or acidifying, by which the nanoparticles are released by removing the acid soluble alkaline earth and alkali matrix typically acid foodstuffs like fruit acids, for example citric acid and malic acid, as well as ascorbic acid, lactic acid, phosphorous acid, saline acid, however also fruit juices or lactic acid foodstuffs such as yogurt and kefir are used.

It is also appropriate under certain conditions to increase the chemical stability of the nanoparticles/nanoclusters by the addition of stabilizators during or after the acidification step; those stabilizators which are suitable, amongst others, are: agar, carob seed powder, pectin, gelatin, xanthan gum, starch, vegetable juices such as garlic juice, alga juice and onion juice, alfalfa and humic substances.

In an especially advantageous embodiment the material to be ground is separated in an ampoule in a separated region of the acid or acid matrix, whereby the dividing wall is opened by external mechanical force, so that inside the ampoule, which preferably is made of flexible plastic, both phases are mixed. Finally the ampoule is opened and the mineral substance solution can be drunk either direct or diluted in water.

Alternatively, a two-chamber bag can be used, whereby both chambers are separated by a seal, which again may be opened by well-directed external pressure on at least one of the two chambers, which finally leads to a mixing together of both phases and so to the release of the correspondingly freed nanoparticles.

Surprisingly even on bringing into contact the dispersed, basic concentrate with crystalline fruit acids—such as citric acids or malic acids—a thin fluid concentrate forms in highly concentrated, highly viscose consistency after a short shaking or stirring, with the thin fluid concentrate being able to easily be diluted with water and can for example can be drunk.

Typically the basic disperse concentrate has a pH value >7, preferably >10 and especially preferably >11. With these pH-values, on account of polarity, the repulsion forces are very high amongst the nanoscale particles, which are bound in the alkaline earth−/alkali matrix, whereby the concentrate reaches its high stability and can be stored for weeks or even months.

Not until the neutralisation/acidification process, the repulsion forces between the nanoparticles then are finally partially lifted, which in the end leads to their subsequent particle growth.

In a further advantageous embodiment bio-organisms are added to the solutions, whereby the nanoclusters are stabilized.

This has the advantage that, in that the nanoparticles/−clusters pass through the cell wall, a nanoparticle can indeed still grow in the inside of the cell, however then cannot diffuse further returning to the solution, so that the agglomeration of the nanoparticles is prevented; these bio-organisms are preferably easily digestible, so that they easily release the trace elements in the digestive area in biologically recoverable modification. Examples of this are bacteria such as lactic acid bacteria, kombucha, effective micro organisms, yogurt bacteria, yeasts and fungi.

It is in addition advantageous, using a special drying method, to transform the nanoscale concentrate into easily dispersable dry substances. This may be achieved according to the state of the art using for example a spray freeze drying, whereby the water surrounding the particle coating is so very quickly removed that there is no sufficient time available for corresponding nanoparticles or supersaturated species to form solid agglomerates or crystals.

In a variation on this the easily dispersable dry substance is formed into capsules, or into tablets in combination with lactose. The forming of an incompletely neutralized concentrate, or correspondingly isolated, easily dispersable dry substances together with crystalline acid, for example citric acid, may be carried out, so that effervescent tablets may be simply be produced, which, immediately before oral ingestion/drinking, release nanoclusters in a drink container according to the invention.

Corresponding products moreover may be used as mineralizing bathing additives.

In addition, according to the invention produced nanoscale and/or supersaturated solutions may be transferred into emulsions, whereby the aqueous phase again is stabilized as nanodroplets then present in an oil matrix. The nanoscale and/or supersaturated mineral species being present in nanodroplets separated from each other can thereby no longer agglomerate in significant quantities.

From the process engineering point of view, corresponding emulsions may be created by using numerous methods. Here should be mentioned the use of a high pressure jet process, by which via suitable dies the aqueous-mineral phase is directed with speeds of between 15 and 1000 m/s, preferably between 30 and 500 m/s towards and in the oil phase and, thereby, emulsifies.

Moreover corresponding emulsions may be made according to the of the state of the art using a rotor strator process, using a membrane process, in particular a premix-membrane process and using an ultrasound process.

Advantageous foodstuff oils like olive oil, sunflower oil, thistle oil, rapeseed oil, sesame oil, nut oil are thereby minerally enriched. In terms of physiological nourishment, the use of the minerals, which are gained from the corresponding press cakes, in order thereby to transfer as many valuable minerals from the original crushed fruit into the emulsion as possible, is thereby especially advantageous.

According to the invention emulsions are thereby not restricted to oil emulsions. Especially interesting embodiments lead also to solidified emulsions, i.e. suitably mineralized margarine and butter types.

The use of accordingly mineralized oils or creams for cosmetics which are used externally is also advantageous.

With the help of the basic process, now generally nanoscale and supersaturated mineral substance and trace element rich solutions may be produced which are generally distinguished by an especially high bio-availability and are therefore predestinated to the use as a mineral substance preparation.

According to the invention nanoscale and/or supersaturated solutions of mineral substance or trace elements are inherently unstable. They have the advantage, nevertheless, that they do not occur in the of the explained production processes until the mixing of two components and are thereby available anywhere and at any time.

Solutions according to the invention are described in a way, that
a) these contain at least 1 chemical element, comprising from the
   A Group of elements, again comprising silicon, iron, aluminum, manganese, chrome, boron, titanium, nickel, copper, zinc, vanadium, molybdenum and cobalt, as well as the
   B Group of the elements, again comprising selenium, zircon, rubidium, lithium, yttrium, cerium, palladium, lanthanum, neodymiumium, silver, wolfram, gallium, tellurium, thorium, praseodymium, niobium, samarium, gadolinium, dysprosium, arsenic, scandium, indium, antimony, cesium, germanium and ytterbium, as well as of the
   C Group of the elements again comprising erbium, europium, bismuth, platiumn, tantalum, terbium, holmium, rubidium, beryllium, gold,
   which
b) forms one or more crystal and/or agglomerate and/or amorphous structures or is embedded into such, which have a growth the in a suitable solution at room temperature inside one hour in the particle diameter between 0.1 nm and 10 μm,
c) whereby this at least 1 chemical element is embedded to a maximum 20 weight % in particles greater than 100 nm.

The crystalline or amorphous structures or agglomerate are typically smaller than 100 nm, and preferably smaller than 80 nm. Each mineral species grows in solutions according to the invention thereby depending on its diameter, typically between 0.1 nm and 10 μm per hour.

Mineral solutions according to the invention may as long as no organic substances or an organic filler substances disturb easily be determined in relation to their particle spectrum with the help of a laser diffraction spectroscope according to the PIDS technique (Polarisation Intensity Differential scattering).

The corresponding particle growth may be determined in dependency on the time by the shifting of the corresponding maxima of the particle distribution, with reference to the particle diameter.

Solutions according to the invention, however, comprise as a rule at least 2 elements from the A-, B-, and C-Group, typically at least 4., preferably at least 6 and especially preferably at least 8 corresponding elements, which in the nanoscale range are present and show a corresponding particle growth.

Especially preferably these particles grow according to their diameter between 1 nm and 1 μm per hour, by which sufficient time remains for the user to take these in a respective solution without time pressure and in a bio-available form.

The growth rate of the particles is defined thereby from the growth of the individual particle in the time frame of one hour after producing the corresponding solution; this time frame can however also be extrapolated for very slowly growing particles using a measurement over a longer time frame. In the case of a preparation of a respective solution of at least two components, here the time frame is reckoned from the moment of the mixing together of both components. The determining that the corresponding element is embedded to maximum 20 weight % in structures greater 100 nm, is determined 5 minutes after the preparation of the solution, in order to make no mistakes arising from the effects of the solution or air bubbles which may occur. In making a preparation with the help of an easily dispersable dry substance, e.g. with a instant powder or granulate, one counts from the moment of the introduction of the respective dry substance into a aqueous liquid, preferably water.

If several unstable species are present the corresponding particle growth speeds may also be determined, in that one sucks or presses the solution according to the invention through a membrane with a defined pore diameter, and measures and statistically evaluates this solution in relationship to time with the help of a Raster Electron Microscope (REM) or of a Transmission Electron Microscope (TEM). By mapping methods the corresponding element distribution may be assigned to the individual particle is e.g. using x-ray dispersion with a micro sonde.

A corresponding indication of the particle size may also immediately be determined using x-ray diffraction on the dried filter cake obtained by using a membrane—even when organic accompanying material prevents direct diffraction measurements of the solution due to an absorbent effect.

Nanoscale and supersaturated solutions of mineral substances or trace elements according to the invention are in this way easily distinguished from normal mineral substance solutions, since they may be placed directly—and without further disintegration—into an IPC-MS analysis device, i.e. they may be sucked in or injected, by which a multitude of the elements contained therein of the A-, B-, and C-Group can be detected in significant quantity. The solution in according to the invention contains elements, which are present therefore not only in a toxicologically unproblematic and bio-available way, but also in a directly analyzable modification.

The high grade produced minerals or elements show, regardless of the eventual matrix effects of the accompanying acid, preferably one or several fruit acid, similar number rates in the mass spectrometer in comparison to a normal hydrogen fluoride acid or an aqua regia disintegration.

With most elements the relative deviation from in comparison to a hydrogen fluoride production is at a maximum 90%, as a rule, however, smaller than 50% and in favourable cases is smaller than 20%, especially if one adds a suitable mineral as internal standard.

As a rule solutions according to the invention contain at least 2, preferably at least 3 chemical elements, which show respective growth properties of the particles. With regard to health aspects it is even advantageous that at least 8 chemical elements are contained in a respective whole mineral substance preparation.

The measurements for particle growth speed are carried out preferably at a total molarity of the alkali and alkaline earth species of 20 mole/l (0.02 mole), i.e. concentrates are correspondingly diluted.

The solutions according to the invention can comprise in concentrate individual mineral species in a concentration range of up to 50 g/l; this applies particularly to calcium and potassium. Typically the remaining elements, however, lie in a concentration range of between 15 g/l and 10 μg/l. The total portion of all mineral-cationic species thereby in the concentrate is typically 20 g/l to 200 g/l, preferably 40 g/l bis 140 g/l.

In a drinkable solution the individual mineral elements lie in a concentration range between 2 g/l for calcium and potassium down to 0.5 μg/l, preferably between 1 g/l and 2 μg/l, whereby the elements of the C-Group as a rule lie in the lower μg-range.

The pH-value of the drinking solution typically lies between 2 and 7, preferably between 3 and 6, whereby at the end a very refreshing taste is created.

If the concentration relationship of the elements of the A-, B-, and C-Group present in each group among one another is in a molar ratio which is for each not greater that 1.000, preferably not greater that 500, these are then in a preferably balanced relationship, which is near to the natural distribution of the elements in our foods and are evaluated as especially advantageous in terms of physiological nourishment.

In a particularly preferred embodiment solutions according to the invention at least 4 of the at least 8 elements, which are present in nanoscale and which show particle growth according to the invention, are embedded up to a maximum of 20 weight % in particles greater 80 nm; so that the bio-availability of the species in relation to the standard is yet further optimized.

In an especially preferred embodiment, at least 60% of all mineral species are smaller that 100 nm in solutions according to the invention; this confirms then that almost all elements contained there in are equipped with a very high bio-availability.

### APPLICATION EXAMPLE

One kg of an extremely pure wood ash was pre-ground with 10 l. water in a rotating grinding bead mill, with grinding bodies of the size 1.5 to 2.5 mm with an energy input of 0.5 kwh/kg (solids) and ground in a second grinding stage with grinding beads of 0.3-0.4 mm and with an energy input of 3 kwh/kg (solids).

The content of calcium carbonate and magnesium carbonate or hydroxides was thereby approx. 50 weight % based on the dry mass, or approx. 5 weight % based on the suspension. The pH-value amounted to approx. 12.

2.0 g of the thus produced suspension were set by means of crystalline citric acid at a pH-value of between 3 and 4 and diluted with 150 ml. water.

The resulting colloidal solution was characterised by means of diffraction measurements (see diagram 1) and mass-spectroscopically examined via an inductively coupled plasma (see table 1).

Including the precedent description, additionally described below are further aspects of the production of nanoparticles, mixtures of nanoparticles, nanoscale solutions, as well as supersaturated solutions in general, especially also such multi-element combinations as well as multi-component mineral substances or multi-component trace-element preparations according to the invention.

The method according to the invention process, involves the following steps:

a) the grinding of a mineral or trace element matrix, which contains at least 2 components of differing brittleness, whereby the matrix contains according to Noack

i) at least 3 elements from the categories of the Cationic Mass Elements (CME) and of the Cationic Core Elements (CCE) and contains

ii) at least 2 elements from the category of the Cationic Periphery Elements (CPE) as well as

b) the at least partial solution of at least one component.

Essential is thereby the grinding of what is in essence a very difficult to grind component, here described as a primary component, that by the considerable effect of secondary components, which because of the comparatively higher brittleness with respect to the primary components are much easier to grind and also because of the large number of contact surfaces to the primary components, work on these highly abrasively and so i) function as a nanoscale grinding tool and ii) work as a separator, in order to keep the less brittle primary material at a distance and thereby work in a protective manner with regard to the re-agglomeration; primary components with regard to the grinding process are materials which have a high tendency to have a metallic oxidation condition, especially the noble elements (CNE) tending to form clusters as well as the alloying elements (CAE) tending to form clusters, to which belong, amongst others, Au, Pt, Pd, Ir, Ag, Os, Cu—in relation to the detailed distribution of the essential elements for the body mineralization see Table 3—which are contained in the matrix to be ground either native or in metallic/alloyed constitution or in the form of salts, for example as oxides, hydroxides, acetates, citrates.

Secondary components in regard to the grinding process are the Basic Ionic Elements (BIE) as well as the not easily soluble ionic elements (Precipitating Ionic Elements (PIE); to which belong among others Ca-, Mg-, K-, Na-, St-, Rb-, Fe-, Zn-salts, and also combinations of those elements, which are preferably ionically present in an aqueous environment.

The process is special in the fact that by the at least partial freeing of one component, especially of secondary components, nanoparticles which have been deposited on the surface of the secondary component as a result of the intensive friction with the primary components, are now desorbed and are released. As a rule these secondary components are in relation to the primary components in a ratio >1, preferably >10 and especially preferably >50.

The determining of the number of the elements, which according to Noack are contained in the mineral matrix, is achieved by using the Biological Mineral Index (BMI), of each respective element.

If an element according to its BMI lies inside the value ranges between the lower limit and upper limit as shown in Table 2, the element is regarded as being present. The BMI is thereby calculated as follows:
BMI(i)=C(i)*b factor/CCEE (G1)
whereby C(i) the substance quantity of the elements represented in mg/kg, “i” stands for any element and the b factor represents a suitable proportionality constant of:
b factor=500 (G2)
and CCEE stands for the Cationic Core Element Equivalent which is calculated as follows:
CCEE=Σst(qu(SBW(j)))*Cj*Tj (G3)
i.e. CCEE is the sum of all standardised, quadratically weighted specific biological values of all CCE (cationic core elements) multiplied by each substance quantity (Cj) and a specific importance factor (Tj): “j” stands here for any element from the group of the CCE, see Table 2.

Each of the standardised, quadratic, specific biological values of the cationic core elements is calculated as follows:
st(qu(SBW(j)))=qu(SBW(j)/Σqu(SBW(j)) (G4)
whereby each quadratically weighted, biological values can be calculated by the difference of each of the mole fractions to the respective primary pattern in question as follows:
qu(SBW(j)=(1/(1+rel. Diff.))² (G5)
whereby:
rel Diff=((Xᵢ−X₀)/Xᵢ)²)^{0.5} (G6)

The higher the number of the elements, the more balanced are the corresponding mineral substance preparations and the higher the value of the clusters in question.

The mineral matrix preferably contains at least 4 elements from the category of the CME or CCE and at least 10 elements from the category of the CPE. Especially preferably the mineral matrix contains at least 5 elements from the category of the CME or CCE and at least 20 elements from the category of the CPE.

The mineral substance components are thereby typically presented as oxides, hydroxides carbonates, hydrogen carbonates, lactates and or as metal powder or granulate.

Preferably the mineral substance matrix essentially consists of ash of plant and/or animal origin.

The ash is typically thermically produced by incinerating organic raw materials, however, it can alternatively also be produced by a plasma process or by reaction of the organic raw material with activated oxygen species.

Preferably wood, nut shells, fruit stones, fruit skins, especially orange and lemon peel, potato skins, olive stones, pine cones, roots, wheat brans, rice skin and aloe vera are used as raw materials for the final product.

Optionally components of the ash, which during the thermal treatment of the raw materials have evaporated are analytically determined and again added in corresponding quantity to the mineral matrix.

In the preferred process already before the grinding the mineral matrix is added to an aqueous solution, which may lead the homogeneity of the process to be increased considerably.

In general all known grinding technologies can be used, preferably in wet milling, ball mills are used whereby the grinding bodies preferably have a diameter of between 0.5 and 2 mm, and especially preferably a diameter between 0.2 and 0.8 mm.

By adding oxidizing species such as hydrogen peroxide, ozone, singlet oxygen or atomic oxygen to the material to be ground or to the suspension, the grinding properties may be improved and in addition any remaining trace of organic incineration residue may be eliminated.

The pH of the suspension during the grinding process is moreover an essential parameter controlling the quality of the grinding process, especially the tendency of the ground particles to reagglomerate. As a rule, a pH is set at >1, preferably >4 and especially preferably >7. In addition, it is preferable to grind different fractions of the material to be ground separately at different pH. values as well as with different stabilizers.

A wet milling also has the advantage, that one can for example integrate a suitable classification in the grinding process. In this way nanoparticles can be isolated or enriched with the help of a suitable membrane or with help of a centrifuge, preferably of an ultra centrifuge. The retentate can then simply be fed to the grinding again.

In the permeate, which in a preferable embodiment is still alkaline and contains BIE particles in considerable quantity, the corresponding release of nanoclusters can be achieved by acidification or by simple dilution with water.

Foodstuffs like citric acid, ascorbin acid, aspartate acid, lactic acid, fruit acids, fruit juices, phosphor acid, humic substances or humic acids and yoghurt are preferably used for acidification.

In an especially advantageous version the solution bio-organisms are added to the solution, whereby the nanoclusters are stabilized.

This has the advantage, that, as the nanoparticles pass through the cell wall, the nanoparticle can indeed still grow in the inside of the cell, however it cannot simply diffuse back in to the solution, whereby agglomeration is prevented; these bio-organisms are preferably easily digestible, so that they easily release trace elements in the digestion area in biologically valuable modification. Examples for this are bacteria such as lactic acid bacteria, combucha, effective micro organisms, yoghurt bacteria, yeasts and fungi.

Optionally, a possible agglomeration of nanoclusters is also avoided by icing e.g. by spontaneous freezing, e.g by liquid air, N2, O2, dry ice, or ice machines.

Nanoclusters or solutions/suspensions according to the invention are preferably made storable by the addition of coordinating/absorbing substances such as e.g. gelatin, agar gar, garlic juice, onion juice, alfalfa, humic substances, vegetable juices, algen juice.

In a preferred variant the material to be ground, or the dried ground powder of the suspension or the correspondingly purified fraction, are processed into capsules, or to tablets in combination with lactose. Especially preferred is the processing together with crystalline acids, for example citric acid, whereby effervescent tablets may be simply produced, which release nanoclusters according to the invention immediately before being taken orally or drunk in a drink container according to the invention. Moreover, corresponding products may be used as a mineralizing bath additive.

With the help of this process a new material substance class can now be produced, particularly nanoclusters and nanocluster mixtures, which posses an especially high biological value. These nanoclusters and nanocluster mixtures contain, according to Noack, at least 3 different elements from the categories of the noble elements (CNE) tending to form clusters and of the alloying elements (CAE) tending to form clusters and have a medium diameter of between 0.3 nm and 50 nm.

Those nanoclusters cause in oral application or when used externally according to own experiments an increase of the particular CNE and CAE in the body fluids, however a subjectively perceptible vitalization was determined.

A suitable process for determining the cluster size is enrich them from an aqueous solution with the help of a carbon capilliary membrane which is evacuated on the inside, and to measure them with the help of a Transmission Electron Microscope (TEM). In order to raise the adhesion of the clusters to the carbon capillary membrane, one can impregnate the membrane with hydrogen iodide.

A further method of characterizing the size of the nanoparticles in a solution exists using the scattering of electromagnetic waves according to the theory of Rayleigh and Debye. Here high energy and monochromatic radiation, for example laser, uv laser or gamma radiation, are preferably used.

A further method for the characterisation of the nanoparticles is by cyano transfer. By this method a highly purified active charcoal, preferably made from coconut shell, is put into a cyanide-containing circulating current, which above all adsorbs the dissolved precious metal species. Here it is crucial that cyanide ions dissolve in the presence of oxygen metallic clusters, wherein the kinetic of the metal dissolution largely depends on the size of the clusters. The greater the amount of the precious metals which are absorbed into the active charcoal per time unit, the smaller the metal clusters which these species release.

Production of High Temperature Activated Active Charcoal (HAC)

Coconut active charcoal, sieved off to a particle diameter of between 2 and 4 mm, having a specific surface area between 950 and 1200 m2/g according to BET is then heated up in a teflon flask with 20% aqueous NaOH for 4 weeks to 100° C.

The charcoal is subsequently extracted again 4 weeks in the soxleth with water. Thereafter follows extraction with a 20 weight % HCl in the soxleth for 3 weeks, whereby after each week the saline acid is exchanged (up to 50 g ac/10 ml/min). Finally once again extraction with water for 4 weeks.

Determination of the Cyano Transfers

Conduct of the Experiment:

with a conc. HCL set up to a pH of between 0.5 and 1.0; stir 1 h at 50° C., set with ammonia up to a pH of between 4 and 5; add KCN, then a 0.3% is set; the solution is put for 1 h in an ultra sound bath and subsequently filtered (x μ); add the filtrate with x g active charcoal per y g ash and put the whole lot in an ultra sound bath while being stirred for 5 min; immediately then suck off by using a frit (5 μm?) and determine the quotient of the NPE to K contained according to Noack; the absorptivity is thereby the relationship of each NPE concentration to potassium in of the starter solution to each relationship to potassium in the filtrate.

Particles smaller than 20 nm contribute to a considerable extent here to the absorption ability, while large clusters are absorbed to a much reduced extent or considerably slower into this active charcoal.

Per each sample in total three tests are carried out at the reaction times of 1, 3, 10.30 and 300 minutes. The absolute loadings of the CNE and CAE at 1, 3, 10, and 30 minutes relative to the 300 minute loadings, multiplied by 100 are described as Cyano Transfer Numbers 1, Cyano Transfer Numbers 3, Cyano Transfer Numbers 10 and Cyano Transfer Numbers 30 or are abbreviated CTN1, CTN3, CTN10 and CTN30 (Cyano Transfer Number). Clusters according to the invention have cyano transfer numbers for the species of the CAE as follows: CTN1>3, CTN3>10, CTN10>15 and CTN30>30. For the species of the CNE the following key values hold true: CTN1>2, CTN3>4, CTN 10>5 and CTN30>20. Preferably holds true for the CAE following values: CTN1>5, CTN3>10, CTN10>20 and CTN30>50. for the CNE the following values preferably hold true: CTN1>4, CTN3>8, CTN10>15 and CTN30>40.

The nanoparticles are as a rule ferro-magnetic, although to a considerably smaller extent than as they are employed for the preparation of electronic data storage devices.

Method for Determining the Component of the Particle Size Between 10 nm and 0.5 nm:

Conduct of the Experiment:

The permeation of each of the elements is determined by the following membranes:

A: NF-PES-10 (Nadir).

B: N-30-F (Nadir)

C: c005F(Nadir)

D: CCM (Carbon Membranes International)

Clusters according to the invention are characterized by containing at least 2 elements whose permeation through at least three membranes differ by a maximum of 40%. Preferably these clusters contain at least 4 elements, the permeation of which through all 4 membranes differ by a maximum of 30%.

The bio-availability directly corresponds with this membrane permeability, since also here the permeability of biological membranes is a precondition for free mobility and the unhindered absorption of the trace elements in the body; the high number of minerals and trace elements contained secures a biologically considerable balance. The quantitative measurement is carried out via IPS/MS. Here it is essential that by the working together of the trace elements from a toxicological point of view the preparation is very much more tolerable, than it is by the isolated provision of the corresponding elements.

In the end, with the described process a new class of highly bio-available and balanced mineral substance and trace element preparations can be produced:

The corresponding mineral substance preparations thereby are distinguished by these:

a. contain according to Noack at least 5 elements from the category of the CME and CCE as well as

b. at least 5 elements from the category of the CPE

c. whereby the clusters contained therein or particle conglomerations of the CNE and CAE are up to at least 80% smaller 20 nm.

A particular feature of mineral substance preparations according to the invention is the option of producing these out of reproductive raw substances. Correspondingly these preparations have the feature, that optionally contained carbon components in relation to a radiochemical 14C—determining of each fraction identifiable with an HPLC according to a corresponding determination of age is not older that 250,000 years, preferably not older that 2,500 years and especially preferably is not older that 25 years.

In addition it is essential that the summary concentration of the CNE lies between the ranges of 1 ppm and 50.000 ppm, preferably between 10 ppm and 5.000 ppm, and especially preferably between 30 and 1000 ppm.

Corresponding quantities of the elements with higher catalytic potency contained here especially have a powerfully health-promoting influence, especially when these are present up to at least 10% in metallic modification.

[image]

Note on Diagram 1: the measurement was determined using the laser diffraction spectroscope method according to the PIDS technique (Polarisation Intensity Differential Scattering) with a spectrometer of the type LS230 made by the company Beckmann-Coulter GmbH/Krefeld, whereby the particle spectrum was calculated and recorded according to volume density distribution q3 (see: H. Rumpf, “Mechanische Verfahrenstechnik”, Carl Hanser Verlag/Munich-Vienna 1995, p. 12-15).

TABLE 1

| Element | | |
|---|---|---|
| (μg/g) | | Wood |
| Ti | Titanium | 1560.10 |
| V | Vanadium | 35.56 |
| Cr | Chrome | 6462.90 |
| Mn | Manganate | 12775.48 |
| Fe | Iron | 24672.32 |
| Co | Cobalt | 19.87 |
| Ni | Nickel | 1062.50 |
| Cu | Copper | 458.90 |
| Zn | Zink | 459.88 |
| Ga | Gallium | 9.88 |
| Ge | Germanium | 3.51 |
| As | Arsenicic | 1.01 |
| Se | Selen | 0.00 |
| Br | Brom | 0.00 |
| Rb | Rubidium | 119.29 |
| Sr | Strontium | 2017.13 |
| Y | Yttrium | 288.40 |
| Zr | Zirconium | 5060.75 |
| Nb | Niobium | 5.62 |
| Mo | Molybdenium | 43.13 |
| Ru | Ruthenium | 0.00 |
| Pd | Palladium | 73.10 |
| Ag | Silver | 29.26 |
| Cd | Cadmium | 23.05 |
| In | Indium | 0.00 |
| Sb | Antimony | 2.87 |
| Te | Tellurium | 7.63 |
| Cs | Cäsium | 1.31 |
| Ba | Barium | 1678.80 |
| La | Lanthan | 14.42 |
| Ce | Cerium | 31.64 |
| Pr | Praseodym | 3.69 |
| Nd | Neodyn | 11.44 |
| Sm | Samarium | 2.43 |
| Eu | Europium | 0.67 |
| Gd | Gadolinium | 1.73 |
| Tb | Terbium | 0.32 |
| Dy | Dysprosium | 1.74 |
| Ho | Holmium | 0.31 |
| Er | Erbium | 0.83 |
| Tm | Thulium | 0.13 |
| Yb | Ytterbium | 1.60 |
| Lu | Lutetium | 0.00 |
| Hf | Hafnium | 127.85 |
| Ta | Tantalum | 0.52 |
| W | Wolfram | 13.68 |
| Re | Rhenium | 0.00 |
| Os | Osmium | 0.00 |
| Ir | Iridium | 0.00 |
| Pt | Platinum | 1.20 |
| Au | Gold | 0.00 |
| Hg | Quicksilver | 0.00 |
| Tl | Thallium | 0.00 |
| Pb | Lead | 13.06 |
| Bi | Bismuth | 0.47 |
| Th | Thorium | 7.04 |
| U | Uranium | 3.21 |
| B | Boron | 1351.22 |
| Al | Aluminium | 38443.71 |
| Si | Silicon | 53238.96 |
| P | Phosphorous | 2713.10 |
| S | Sulphur | 14701.15 |
| Se | Selenium | 0.00 |
| Br | Bromineium | 0.00 |
| Li | Lithium | 52.20 |
| Be | Berylium | 0.00 |
| Na | Natrium | 19883.98 |
| Mg | Magnesium | 60715.70 |
| K | Potassium | 106809.43 |
| Ca | Calcium | 252354.22 |
| Sc | Scandium | 4.02 |
| Rb | Rubidium | 119.29 |
| Sr | Strontium | 2017.13 |
| Cs | Caesium | 1.31 |
| Ba | Barium | 1678.80 |

TABLE 2
(for the characterisation of the mineral substance
matrix or of mineral substance preparations)

BMI

| | Lower Limit | Upper Limit |
|---|---|---|
| Li | 2.00 | 124.72 |
| Na | 249.44 | 16213.40 |
| K | 748.31 | 74831.06 |
| Rb | 0.075 | 49.89 |
| Cs | 0.025 | 6.24 |
| Be | 0.025 | 6.24 |
| Mg | 3741.6 | 22449.32 |
| Ca | 9977.5 | 52381.74 |
| Sr | 1.25 | 523.82 |
| Ba | 1.25 | 523.82 |
| Sc | 0.012 | 4.99 |
| Y | 0.062 | 19.95 |
| La | 0.062 | 24.94 |
| Ti | 3.118 | 62.36 |
| Zr | 0.125 | 74.83 |
| Hf | 0.012 | 1.25 |
| V | 0.050 | 19.95 |
| Nb | 0.012 | 2.49 |
| Ta | 0.0012 | 1.25 |
| Cr | 0.125 | 19.95 |
| Mo | 0.075 | 14.97 |
| W | 0.050 | 9.98 |
| Mn | 12.472 | 187.08 |
| Re | 0.012 | 12.47 |
| Fe | 74.831 | 498.87 |
| Ru | 0.0002 | 2.49 |
| Os | 0.0002 | 2.49 |
| Co | 0.9977 | 19.95 |
| Rh | 0.0002 | 2.49 |
| Ir | 0.0002 | 2.49 |
| Ni | 0.2494 | 12.47 |
| Pd | 0.0002 | 2.49 |
| Pt | 0.0002 | 2.49 |
| Cu | 12.4718 | 124.72 |
| Ag | 0.0012 | 12.47 |
| Au | 0.0002 | 2.49 |
| Zn | 24.9437 | 249.44 |
| Cd | 0.0002 | 0.50 |
| Hg | 0.0001 | 0.12 |
| B | 12.4718 | 1247.18 |
| Al | 2.4944 | 124.72 |
| Ga | 0.0025 | 2.49 |
| In | 0.0002 | 2.00 |
| Tl | 0.0001 | 0.50 |
| Si | 24.9437 | 2454.37 |
| Ge | 0.1247 | 12.47 |
| Sn | 0.0249 | 24.94 |
| Pb | 0.0002 | 4.99 |
| As | 0.0125 | 12.47 |
| Sb | 0.0025 | 2.49 |
| Bi | 0.0002 | 0.62 |
| Se | 0.0499 | 9.98 |
| Te | 0.0002 | 0.50 |
| F | 0.1247 | 12.47 |
| Br | 0.0249 | 2.49 |
| I | 0.0125 | 12.47 |
| Ce | 0.0249 | 12.47 |
| Pr | 0.0125 | 2.49 |
| Nd | 0.0249 | 9.98 |
| Sm | 0.0249 | 2.49 |
| Eu | 0.0012 | 1.25 |
| Gd | 0.0025 | 2.49 |
| Tb | 0.0012 | 1.25 |
| Dy | 0.0025 | 2.49 |
| Ho | 0.0025 | 2.49 |
| Er | 0.0025 | 2.49 |
| Tm | 0.0025 | 2.49 |
| Yb | 0.0025 | 2.49 |
| Lu | 0.0012 | 1.25 |
| Th | 0.0012 | 1.25 |

TABLE 3

| | Sample relationship | Weighing factor |
|---|---|---|
| Mn | 1.2E−02 | 4 |
| Fe | 2.3E−01 | 3 |
| Cu | 1.0E−01 | 10 |
| Zn | 6.5E−01 | 6 |
| Co | 4.1E−03 | 8 |

TABLE 4

| | |
|---|---|
| CME | Cationic Mass Elements |
| CCE | Cationic Core Elements |
| CPE | Cationic Periphery Elements |
| AAE | Acidic Anionic Elements |
| BIE | Basic Ionic Elements |
| PIE | Preciptating Ionic Elements |
| CNE | Clustering Noble Elements |
| CAE | Clustering Alloying Elements |
| HACE | High Active Catalytic Elements |
| MACE | Medium Active Catalytical Elements |
| LACE | Low Active Catalytic Elements |
| ACE | Auxilluary Catalytic Elements |
| ISE | Inactivating Substitutional Elements |
| CCM | Carbon Capillary Membrane |
| REM | Raster Electron Microscope |
| TEM | Transmission Electron Microscope |
| BMI | Biological Mineral Index |
| CCEE | Cationic Core Element Equivalent |

TABLE 5
(for the characterisation of nanoclusters
and mixtures of nanoclusters)

Cluster

| | Lower Limit | Upper Limit |
|---|---|---|
| Li | 0.0000 | 0.0000 |
| Na | 0.0000 | 0.0000 |
| K | 0.0000 | 0.0000 |
| Rb | 0.0000 | 0.0000 |
| Cs | 0.0000 | 0.0000 |
| Be | 0.0000 | 0.0000 |
| Mg | 0.0000 | 0.0000 |
| Ca | 0.0000 | 0.0000 |
| Sr | 0.0000 | 0.0000 |
| Ba | 0.0000 | 0.0000 |
| Sc | 0.0000 | 0.0000 |
| Y | 0.0000 | 0.0000 |
| La | 0.0000 | 0.0000 |
| Ti | 0.0000 | 0.0000 |
| Zr | 0.0000 | 0.0000 |
| Hf | 0.0000 | 0.0000 |
| V | 0.1497 | 59.8649 |
| Nb | 0.0374 | 7.4831 |
| Ta | 0.0037 | 3.7416 |
| Cr | 0.3742 | 59.8649 |
| Mo | 0.2245 | 44.8986 |
| W | 0.1497 | 29.9324 |
| Mn | 0.0000 | 0.0000 |
| Re | 0.0374 | 37.4155 |
| Fe | 224.4932 | 1496.6213 |
| Ru | 0.0007 | 7.4831 |
| Os | 0.0007 | 7.4831 |
| Co | 2.9932 | 59.8649 |
| Rh | 0.0007 | 7.4831 |
| Ir | 0.0007 | 7.4831 |
| Ni | 0.7483 | 37.4155 |
| Pd | 0.0007 | 7.4831 |
| Pt | 0.0007 | 7.4831 |
| Cu | 37.4155 | 374.1553 |
| Ag | 0.0037 | 37.4155 |
| Au | 0.0007 | 7.4831 |
| Zn | 0.0000 | 0.0000 |
| Cd | 0.0007 | 1.4966 |
| Hg | 0.0002 | 0.3742 |
| B | 0.0000 | 0.0000 |
| Al | 0.0000 | 0.0000 |
| Ga | 0.0000 | 0.0000 |
| In | 0.0007 | 5.9865 |
| Tl | 0.0002 | 1.4966 |
| Si | 0.0000 | 0.0000 |
| Ge | 0.3742 | 37.4155 |
| Sn | 0.0748 | 74.8311 |
| Pb | 0.0007 | 14.9662 |
| As | 0.0374 | 37.4155 |
| Sb | 0.0075 | 7.4831 |
| Bi | 0.0007 | 1.8708 |
| Se | 0.0000 | 0.0000 |
| Te | 0.0000 | 0.0000 |
| F | 0.0000 | 0.0000 |
| Br | 0.0000 | 0.0000 |
| I | 0.0000 | 0.0000 |
| Ce | 0.0748 | 37.4155 |
| Pr | 0.0374 | 7.4831 |
| Nd | 0.0748 | 29.9324 |
| Sm | 0.0748 | 7.4831 |
| Eu | 0.0037 | 3.7416 |
| Gd | 0.0075 | 7.4831 |
| Tb | 0.0037 | 3.7416 |
| Dy | 0.0075 | 7.4831 |
| Ho | 0.0075 | 7.4831 |
| Er | 0.0075 | 7.4831 |
| Tm | 0.0075 | 7.4831 |
| Yb | 0.0075 | 7.4831 |
| Lu | 0.0037 | 3.7416 |
| Th | 0.0037 | 3.7416 |

1. A method for the production of nanoparticles, mixtures of nanoparticles, nanoscale solutions, as well as supersaturated solutions in general, said method comprising:
a) providing the presence of a suspension, which contains:
i) at least 1 element from the group consisting of alkali and alkaline earth elements, in a concentration range which contains between 1.0 and 50 weight %, which is at least up to 50 weight % present in at least one of a mineral form and ionically not easily soluble form, and
ii) at least 1 element from one of the:
A Group of the elements, comprising silicon, iron, aluminum, manganese, chrome, boron, titanium, nickel, copper, zinc, vanadium, molybdenum and cobalt,
B Group of the elements, comprising selenium, zircon, rubidium, lithium, yttrium, cerium, palladium, lanthanum, neodymiumium, silver, wolfram, gallium, tellurium, thorium, praseodymium, niobium, samarium, gadolinium, dysprosium, arsenic, scandium, indium, antimony, cesium, germanium and ytterbium, and
C Group of the elements comprising erbium, europium, bismuth, platinum, tantalum, terbium, holmium, rubidium, beryllium, gold and rhodium,
iii) in a molar ratio referred to the sum of the alkali and alkaline earth elements between 0.1% and 30%;
b) introducing particle dismembering or dispersing energy in the suspension by retention of a dispersed concentrate; and
c) mixing the dispersed concentrate with acid.

2. A method according to claim 1,
characterized in that at least 2 alkaline earth elements are contained in a concentration range contain between 1.0 and 50 weight %.

3. A method according to claim 1,
characterized in that at least one alkaline earth component is present as at least one of oxide, hydroxide, carbonate, and hydrogen carbonate.

4. A method according to claim 1,
characterized in that the suspension contains at least 4 elements from the A Group of the elements, in a molar ratio, each referred to the sum of the alkali and alkaline earth elements between 0.1% and 30%.

5. A method according to claim 1,
characterized in that the suspension contains at least 4 elements from the B Group of the elements in a molar ratio, each referred to the sum of the elements from the A Group, between 0.05% and 30%.

6. A method according to claim 1,
characterized in that the suspension contains at least 4 elements from the C Group of the elements in a molar ratio, each referred to the sum of the elements from the B Group, between 0.05% and 30%.

7. A method according to claim 1,
characterized in that a mineral substance matrix substantially consists of ash of at least one of plant origin and animal origin.

8. A method according to claim 7,
characterized in that the ash is produced in accordance with at least one of: i) a thermally-oxidizing manner, ii) a plasma process, and iii) reaction of organic raw substances with activated oxygen species.

9. A method according to claim 8,
characterized in that as said organic raw substances, at least one of wood, nut shells, fruit stones, fruit skins, potato skins, olive stones, pine cones, roots, wheat husks, and rice husks are used.

10. A method according to claim 1,
characterized in that at least one of Press cakes and extraction residues are used as resultant products.

11. A method according to claim 7,
characterized in that components or minerals from the group of the iodine, bromine, fluoride salts and selenium combinations are added to the ash.

12. A method according to claim 1,
characterized in that the suspension is ground or dispersed at a pH>7.

13. A method according to claim 1,
characterized in that oxidizing species are added to the suspension.

14. A method according to claim 1,
characterized in that of the distributing or dispersion process is carried out with the help of one of a ball mill, bead mill, colloidal mill, centrifugal mill and high pressure jet.

15. A method according to claim 1,
characterized in that in the dispersion process, energies are introduced, referred to the tonne solids, of between 100 and 100,000 kwh.

16. A method according to claim 1,
characterized in that of the medium diameter of the primary grinding bodies lies between 0.05 and 2 mm.

17. A method according to claim 1,
characterized in that the ground up suspension is classified by means of one of the following: at least one centrifuge, at least one membrane, and at least one sieve.

18. A method according to claim 1,
characterized in that the acid is added in the form of at least one foodstuff material from the group comprising citric acid, malic acid and other fruit acids, as well as ascorbic acid, lactic acid, fruit juices, phosphorous acid, saline acid as well as mixtures of the same.

19. A method according to claim 1,
characterized in that the disperse concentrate is temporarily stored and is not mixed with the acid until shortly before use.

20. A method according to claim 1,
characterized in that bio-organisms are added to the solution for stabilisation

21. A method according to claim 1,
characterized in that as bio-organisms stabilizing the nanoparticles bacteria are used.

22. A method according to claim 1,
characterized in that the suspension containing nanoparticles is stabilized chemically by the addition of coordinating/absorbing substances.

23. A method for the production of an easily pulverizable dry substance of a nanoscale or supersaturated solution of mineral substances and trace elements, said method comprising:
a) providing the presence of a suspension that contains:
i) at least 1 element from the group consisting of alkali and alkaline earth elements, in a concentration range which contains between 1.0 and 50 weight %, which is at least up to 50 weight % present in at least one of a mineral form and ionically not easily soluble form, and
ii) at least 1 element from one of the:
A Group of the elements, comprising silicon, iron, aluminum, manganese, chrome, boron, titanium, nickel, copper, zinc, vanadium, molybdenum and cobalt,
B Group of the elements, comprising selenium, zircon, rubidium, lithium, yttrium, cerium, Palladium, lanthanum, neodymiumium, silver, wolfram, gallium, tellurium, thorium, praseodymium, niobium, samarium, gadolinium, dysprosium, arsenic, scandium, indium, antimony, cesium, germanium and ytterbium, and
C Group of the elements comprising erbium, europium, bismuth, platinum, tantalum, terbium, holmium, rubidium, beryllium, gold and rhodium.
iii) in a molar ratio referred to the sum of the alkali and alkaline earth elements between 0.1% and 30%;
b) introducing particle dismembering or dispersing energy in the suspension by retention of a dispersed concentrate; and
c) mixing the dispersed concentrate with acid;
wherein the nanoscale solution is converted with the help of a suitable drying process.

24. A method according to claim 23,
characterized in that the dry substance easily dispersable at nanoscale is processed into at least one of a granulate, tablets, and capsules.

25. A method according to claim 23,
characterized in that the easily dispersable dry substance is mixed with crystalline acid and is optionally processed into one of tablets, granulate, and capsules.

26. A device for the production or for the activation of mineral substance preparations comprising at least two segments locally being separated by a seal, wherein a first segment of said at least two segments contains substantially disperse concentrate and a second segment of said at least two segments contains acid, and wherein the seal is able to be opened by definite pressure on at least one of said first segment and said second segment, whereby the contents of both segments come into contact with each other.

27. A solution of mineral substance or trace elements said solution comprising:
a) at least 1 chemical element from one of the:
A-Group of the elements, comprising silicon, iron, aluminum, manganese, chrome, boron, titanium, nickel, copper, zinc, vanadium, molybdenum and cobalt,
B-Group of the elements, comprising selenium, zircon, rubidium, lithium, yttrium, cerium, palladium, lanthan, neodymium, silver, wolfram, gallium, tellurium, thorium, praseodym, niobium, samarium, gadolinium, dysprosium, arsenic, scandium, indium, antimony, cesium, germanium and ytterbium, and
C Group of the elements comprising erbium, europium, bismuth, platinum, tantalum, terbium, holmium, rubidium, beryllium, gold,
which said at least 1 chemical element:
i) forms at least one of crystals, agglomerates, and amorphous structures, or is embedded into such,
ii) which in a respective solution at room temperature within one hour has a growth in size in particle diameter between 0.1 nm and 10 μm; and
b) surrounding material;
wherein said at least 1 chemical element is embedded in said surrounding material to a maximum of 20 weight % in particles greater than 100 nm.

28. A solution according to claim 27,
characterized in that:
a) said solution comprises at least 2 chemical elements from at least one of:
said A Group of the elements,
said B Group of the elements, and
said C Group of the elements,
i) wherein said at least 2 chemical elements form at least one of crystals, agglomerates, and amorphous structures, or are embedded into such,
ii) which in a respective solution at room temperature within one hour have a growth in particle diameter between 0.1 nm and 10 μm, and
b) said at least 2 chemical elements are embedded in said surrounding material to a maximum of 20 weight % in particles greater than 100 nm.

29. A solution according to claim 28,
characterized in that
a) said solution comprises at least 4 chemical elements from at least one of:
said A Group of the elements,
said B Group of the elements, and
said C Group of the elements,
wherein said at least 4 chemical elements form at least one of crystals, agglomerates, and amorphous structures, or are embedded into such,
ii) which in a respective solution at room temperature within one hour have a growth in particle diameter between 0.1 nm and 10 μm, and
b) said at least 4 chemical elements are embedded in said surrounding material to a maximum of 20 weight % in particles greater than 100 nm.

30. A solution according to claim 29,
characterized in that
a) said solution comprises at least 6 chemical elements from at least one of:
said A Group of the elements,
said B Group of the elements, and
said C Group of the elements,
i) wherein said at least 6 chemical elements form at least one of crystals, agglomerates, and amorphous structures, or are embedded into such,
ii) which in a respective solution at room temperature within one hour have a growth in particle diameter between 0.1 nm and 10 μm, and
b) said at least 6 chemical elements are embedded in said surrounding material to a maximum of 20 weight % in particles greater than 100 nm.

31. A solution according to claim 30,
a) said solution comprises at least 8 chemical elements from at least one of:
said A Group of the elements,
said B Group of the elements, and
said C Group of the elements,
i) wherein said at least 8 chemical elements form at least one of crystals, agglomerates, and amorphous structures, or are embedded into such,
ii) which in a respective solution at room temperature within one hour have a growth in particle diameter between 0.1 nm and 10 μm, and
b) said at least 8 chemical elements are embedded in said surrounding material to a maximum of 20 weight % in particles greater than 100 nm.

32. A solution according to claim 31,
characterized in that the particle growth speed is between 1 nm and 1 μm per hour.

33. A solution according to claim 31,
characterized in that at least 2 of the at least 8 elements are present in the concentration range between 30 g/l and 10 mg/l.

34. A solution according to claim 31,
characterized in that at least 4 of the at least 8 elements are present in a concentration range between 30 g/l and 10 mg/l.

35. (canceled)

36. N A solution according to claim 31,
characterized in that at least 4 of the at least 8 elements are embedded in said surrounding material to maximum 20 weight. % in particles greater 80 nm.

37. A solution according to claim 31,
characterized in that at least 4 of the at least 8 elements stem from the group comprising gold, silver, platinum, bismuth, copper, palladium, iron, and wolfram.

38. A solution according to claim 27,
characterized in that the metallic or metalloid or cationic species contained therein is substantially obtained from the incineration of one of plant raw materials and animal raw materials.

39. A solution according to claim 27,
characterized in that at least 60% of all mineral species are smaller that 100 nm.

40. A solution according to claim 27,
characterized in that at least 80% of all mineral species are smaller that 100 nm.

41. (canceled)

42. A method for the production of nanoscale emulsions, said method comprising:
a) providing the presence of a suspension that contains:
i) at least element from the group consisting of alkali and alkaline earth elements, in a concentration range which contains between 1.0 and 50 weight %, which is at least up to 50 weight % present in at least one of a mineral form and ionically not easily soluble form, and
ii) at least 1 element from one of the following groups of elements:
A Group of the elements, comprising silicon, iron, aluminum, manganese, chrome, boron, titanium, nickel, copper, zinc, vanadium, molybdenum and cobalt,
B Group of the elements, comprising selenium, zircon, rubidium, lithium, yttrium, cerium, palladium, lanthanum, neodymiumium, silver, wolfram, gallium, tellurium, thorium, praseodymium, niobium, samarium, gadolinium, dysprosium, arsenic, scandium, indium, antimony, cesium, germanium and ytterbium, and
C Group of the elements comprising erbium, europium, bismuth, platinum, tantalum, terbium, holmium, rubidium, beryllium, gold and rhodium
iii) in a molar ratio referred to the sum of the alkali and alkaline earth elements between 0.1% and 30%;
b) introducing particle dismembering or dispersing energy in the suspension by retention of a dispersed concentrate; and
c) mixing the dispersed concentrate with acid;
wherein the mineral substances of the disperse phase are introduced in supersaturated form into an oil.

43. A method according to claim 42,
characterized in that the mineral substance-rich solution is introduced into the oil phase by means of one of the following: a rotor/stator system, a membrane process, an ultrasound process, a premix process, and a high pressure-jet process at a jet speed of between 30 m/s and 500 m/s.
